(19) United States
(12) Patent Application Publication
(10) Pub. No.: US 2016/0054487 A1
(43) Pub. Date: Feb. 25, 2016

(54) MULTILAYER MIRROR ASSEMBLY

(71) Applicant: SOLVAY SPECIALTY POLYMERS ITALY S.P.A., Bollate (MI) (IT)

(72) Inventors: Paula COJOCARU, Legnano (IT); Stefano MORTARA, Arconate (IT); Marco APOSTOLO, Senago (IT); Francesco TRIULZI, Milano (IT)

(21) Appl. No.: 14/779,453

(22) PCT Filed: Mar. 26, 2014
(86) PCT No.: PCT/EP2014/056026

§ 371 Date: Sep. 23, 2015

(30) Foreign Application Priority Data
Mar. 29, 2013 (EP) 13161828.2

(51) Int. Cl. G02B 5/08; C23C 18/31; G02B 19/00

(52) U.S. Cl. CPC G02B 5/0858; G02B 19/0042; G02B 19/0019; C23C 18/31

(57) ABSTRACT

The present invention pertains to a process for the manufacture of a multilayer mirror assembly, to the multilayer mirror assembly thereby provided and to uses of said multilayer mirror assembly in various applications.

This application claims priority to European application No. 13161828.2 filed on Mar. 29, 2013, the whole content of this application being incorporated herein by reference for all purposes.

### TECHNICAL FIELD

The present invention pertains to a multilayer mirror assembly, to a process for the manufacture of said multilayer mirror assembly and to uses of said multilayer mirror assembly in various applications.

### BACKGROUND ART

Solar power is the conversion of sunlight into electricity either directly using photovoltaic systems (PV) or indirectly using concentrated solar power systems (CSP).

Concentrated solar power (CSP) technology typically uses lenses or reflectors and tracking systems to focus a large area of electromagnetic incident radiation into a small beam. The concentrated radiation is then used as a heat source for a conventional power plant. Among the most developed concentration technologies mention can be made of parabolic trough concentrators.

Concentrated photovoltaic (CPV) technology typically uses reflectors suitable for concentrating incident radiation onto photovoltaic cells. The photovoltaic cells then convert radiation into electric current using the photoelectric effect.

Reflectors suitable for use in said CSP and CPV technologies are commonly based on mirror films. Metals are the most common materials for mirror fabrication due to their inherent reflection properties.

The reflectivity generally refers to the fraction of incident electromagnetic radiation that is reflected at an interface and typically varies as a function of the wavelength of the incident radiation and as a function of the angle of the incident radiation at the interface.

The reflectivity of a metal surface is however usually altered by the build up of oxides leading to metal corrosion due to the chemical action of gases present in the atmosphere.

Thin non-metallic films on metallic mirrors are thus being more and more often used in optical practice for the protection of the metal against corrosion.

For instance, US 2012/0182607 (EVONIK DEGUSSA GMBH) 19.07.2012 discloses a process for producing self-supporting concentrators for systems for power generation wherein a highly transparent polymer layer is coated with a silver mirror layer by physical vapour deposition.

Nevertheless, a primer layer is typically applied between the polymer layer and the metal layer thereby contributing to long-life performance of the concentrator.

Also, DE 3709208 (BOMIN SOLAR GMBH) 29.09.1988 discloses a mirror assembly comprising a plastic support layer adhered to a fluoropolymer layer through a metal layer. The metal layer is coated on the plastic support layer by physical vapour deposition.

It is also known in the art to promote adhesive bonding of metals to fluoropolymer surfaces through sputtering or ion bombardment processes. However, these methods can adversely affect the chemical and morphological characteristics of the surface.

Accordingly, there still remains a need in the art for a process for the metallization of optically transparent polymer substrates ensuring continuous coating of the polymer layer with a metal layer so as to maintain reflected radiation on a target of at least 90% of the incident electromagnetic radiation and efficiently protect the metal layer against corrosion, while leaving bulk properties of the optically transparent polymer layer unaffected.

### SUMMARY OF INVENTION

It has been now surprisingly found that the multilayer mirror assembly obtainable by the process of the invention is advantageously provided with enhanced interlayer adhesion properties while exhibiting outstanding reflection properties and maintaining outstanding flexibility and weatherability properties.

In particular, the multilayer mirror assembly of the invention can withstand extreme environmental conditions due to chemical resistance, soil repellency and scratch resistance of the outer fluoropolymer layer while advantageously providing for homogeneous reflection of incident solar radiation over its entire outer surface.

In addition, the multilayer mirror assembly of the invention is advantageously endowed with good mechanical properties and is resistant to breakage while maintaining outstanding flexibility over the long term.

In a first aspect, the present invention pertains to a process for the manufacture of a multilayer mirror assembly, said process comprising the following steps:

(i) providing an optically transparent layer [layer (L1)] made of a composition [composition (C1)] comprising, preferably consisting of, at least one fluoropolymer [polymer (F)], said layer (L1) having an inner surface and an outer surface,

(ii) treating the inner surface of the layer (L1) by a radio-frequency glow discharge process in the presence of an etching gas,

(iii) applying by electroless deposition a metal layer [layer (L2)] onto the treated inner surface of the layer (L1) as provided in step (ii), said layer (L2) being made of a composition [composition (02)] comprising at least one metal compound [compound (M)],

(iv) optionally, applying by electro-deposition a metal layer [layer (L3)] onto the opposite side of the layer (L2) as provided in step (iii), said layer (L3) being made of a composition [composition (03)] comprising at least one metal compound [compound (M)], said composition (03) being equal to or different from composition (02), and

(v) optionally, applying one or more further layers onto the opposite side of the layer (L2) as provided in step (iii) or the layer (L3) as provided in step (iv).

In a second aspect, the present invention pertains to a multilayer mirror assembly obtainable by the process of the invention.

The multilayer mirror assembly of the invention typically comprises:
a layer [layer (L1)] made of a composition [composition (C1)] comprising, preferably consisting of, at least one fluoropolymer [polymer (F)], said layer (L1) having an inner surface and an outer surface, wherein the inner surface is treated by a radio-frequency glow discharge process in the presence of an etching gas,
directly adhered to the treated inner surface of the layer (L1), a metal layer [layer (L2)] made of a composition [composition (C2)] comprising at least one metal compound [compound (M)],
optionally, directly adhered to the opposite side of the layer (L2), a metal layer [layer (L3)] made of a composition [composition (C3)] comprising at least one compound (M), said composition (C3) being equal to or different from composition (C2), and
optionally, directly adhered to the opposite side of the layer (L2) or the layer (L3), one or more further layers.

The multilayer mirror assembly preferably comprises:
a layer [layer (L1)] made of a composition [composition (C1)] comprising, preferably consisting of, at least one fluoropolymer [polymer (F)], said layer (L1) having an inner surface and an outer surface, wherein the inner surface is treated by a radio-frequency glow discharge process in the presence of an etching gas,
directly adhered to the treated inner surface of the layer (L1), a metal layer [layer (L2)] made of a composition [composition (C2)] comprising at least one metal compound [compound (M)],
directly adhered to the opposite side of the layer (L2), a metal layer [layer (L3)] made of a composition [composition (C3)] comprising at least one compound (M), said composition (C3) being equal to or different from composition (C2), and
optionally, directly adhered to the opposite side of the layer (L3), one or more further layers.

The process for the manufacture of a multilayer mirror assembly preferably comprises the following steps:

(i) providing an optically transparent layer [layer (L1)] made of a composition [composition (C1)] comprising, preferably consisting of, at least one fluoropolymer [polymer (F)], said layer (L1) having an inner surface and an outer surface,

(ii) treating the inner surface of the layer (L1) by a radio-frequency glow discharge process in the presence of an etching gas,

(iii) applying by electroless deposition a metal layer [layer (L2)] onto the treated inner surface of the layer (L1) as provided in step (ii), said layer (L2) being made of a composition [composition (C2)] comprising at least one metal compound [compound (M)],

(iv) applying by electro-deposition a metal layer [layer (L3)] onto the opposite side of the layer (L2) as provided in step (iii), said layer (L3) being made of a composition [composition (C3)] comprising at least one metal compound [compound (M)], said composition (C3) being equal to or different from composition (C2), and

(v) optionally, applying one or more further layers onto the opposite side of the layer (L3) as provided in step (iv).

In a third aspect, the present invention pertains to use of the multilayer mirror assembly of the invention in various applications including, but not limited to, solar concentrators.

Thus, in a fourth aspect, the present invention pertains to a process for the manufacture of a solar concentrator, said process comprising the following steps:

(i) providing an optically transparent layer [layer (L1)] made of a composition [composition (C1)] comprising, preferably consisting of, at least one fluoropolymer [polymer (F)], said layer (L1) having an inner surface and an outer surface,

(ii) treating the inner surface of the layer (L1) by a radio-frequency glow discharge process in the presence of an etching gas,

(iii) applying by electroless deposition a metal layer [layer (L2)] onto the treated inner surface of the layer (L1) as provided in step (ii), said layer (L2) being made of a composition [composition (C2)] comprising at least one metal compound [compound (M)],

(iv) optionally, applying by electro-deposition a metal layer [layer (L3)] onto the opposite side of the layer (L2) as provided in step (iii), said layer (L3) being made of a composition [composition (C3)] comprising at least one metal compound [compound (M)], said composition (C3) being equal to or different from composition (C2), and

(v) optionally, applying one or more further layers onto the opposite side of the layer (L2) as provided in step (iii) or of the layer (L3) as provided in step (iv).

The process for the manufacture of a solar concentrator preferably comprises the following steps:

(i) providing an optically transparent layer [layer (L1)] made of a composition [composition (C1)] comprising, preferably consisting of, at least one fluoropolymer [polymer (F)], said layer (L1) having an inner surface and an outer surface,

(ii) treating the inner surface of the layer (L1) by a radio-frequency glow discharge process in the presence of an etching gas,

(iii) applying by electroless deposition a metal layer [layer (L2)] onto the treated inner surface of the layer (L1) as provided in step (ii), said layer (L2) being made of a composition [composition (C2)] comprising at least one metal compound [compound (M)],

(iv) applying by electro-deposition a metal layer [layer (L3)] onto the opposite side of the layer (L2) as provided in step (iii), said layer (L3) being made of a composition [composition (C3)] comprising at least one metal compound [compound (M)], said composition (C3) being equal to or different from composition (C2), and

(v) optionally, applying one or more further layers onto the opposite side of the layer (L3) as provided in step (iv).

In a fifth aspect, the present invention also pertains to a solar concentrator comprising at least one multilayer mirror assembly according to the invention.

The solar concentrator is advantageously obtainable by the process of the invention.

According to a first embodiment of the invention, the solar concentrator of the invention comprises:
at least one multilayer mirror assembly according to the invention, and
a heat transfer fluid.

According to a second embodiment of the invention, the solar concentrator of the invention comprises:
at least one multilayer mirror assembly according to the invention, and
a photovoltaic cell.

The layer (L1) is optically transparent to incident electromagnetic radiation.

The thickness of the layer (L1) is not particularly limited; it is nevertheless understood that layer (L1) will have typically a thickness of at least 5 μm, preferably of at least 10 μm. Layers (L1) having thickness of less than 5 μm, while still suitable for the multilayer mirror assembly of the invention, will not be used when adequate mechanical resistance is required.

As per the upper limit of the thickness of the layer (L1), this is not particularly limited, provided that said layer (L1) still can provide the optical transparency and flexibility required for the particular field of use targeted.

The layer (L1) has typically a thickness of at most 300 μm, preferably of at most 200 μm.

The skilled in the art, depending on the nature of the polymer (F), will select the proper thickness of the layer (L1) so as to provide for the optical transparency required.

The outer surface of the layer (L1) is typically exposed to incident electromagnetic radiation.

The optically transparent layer (L1) advantageously has a transmittance of at least 70%, preferably of at least 80%, more preferably of at least 85% of the incident electromagnetic radiation.

The transmittance can be measured according to any suitable techniques.

By “electromagnetic radiation”, it is hereby intended to denote solar radiation having a wavelength comprised between 300 nm and 2500 nm, preferably between 400 nm and 2500 nm.

When assembled into the multilayer mirror assembly of the invention, at least by applying by electroless deposition a metal layer (L2) onto the treated inner surface of the layer (L1), the outer surface of the layer (L1) is advantageously able to reflect incident electromagnetic radiation.

The Applicant has surprisingly found that the treated inner surface of the layer (L1) is successfully continuously adhered to a metal layer (L2) and, optionally, to a metal layer (L3).

The Applicant has thus also found that the multilayer mirror assembly of the invention advantageously provides for a reflection of at least 90% of the incident electromagnetic radiation.

The reflection can be measured according to any suitable techniques.

The term “fluoropolymer [polymer (F)]” is understood to mean a fluoropolymer comprising recurring units derived from at least one fluorinated monomer.

By the term “fluorinated monomer”, it is hereby intended to denote an ethylenically unsaturated monomer comprising at least one fluorine atom.

The term “at least one fluorinated monomer” is understood to mean that the polymer (F) may comprise recurring units derived from one or more than one fluorinated monomers. In the rest of the text, the expression “fluorinated monomers” is understood, for the purposes of the present invention, both in the plural and the singular, that is to say that they denote both one or more than one fluorinated monomers as defined above.

Non limitative examples of suitable fluorinated monomers include, notably, the followings:
C₃-C₈ perfluoroolefins, such as tetrafluoroethylene (TFE) and hexafluoropropene (HFP);
C₂-C₈ hydrogenated fluoroolefins, such as vinylidene fluoride (VDF), vinyl fluoride, 1,2-difluoroethylene and trifluoroethylene (TrFE);
perfluoroalkylethylenes of formula CH₂═CH—R_{f0} wherein R_{f0} is a C₁-C₆ perfluoroalkyl group;
chloro- and/or bromo- and/or iodo-C₂-C₆ fluoroolefins, such as chlorotrifluoroethylene (CTFE);
(per)fluoroalkylvinylethers of formula CF₂═CFORn wherein R_{f1} is a C₁-C₆ fluoro- or perfluoroalkyl group, e.g. CF₃, C₂F₅, C₃F₇; —CF₂═CFOX₀ (per)fluoro-oxyalkylvinylethers, wherein X₀ is a C₁-C₁₂ alkyl group, a C₁-C₁₂ oxyalkyl group or a C₁-C₁₂ (per)fluorooxyalkyl group comprising one or more ether groups, such as perfluoro-2-propoxy-propyl group;
(per)fluoroalkylvinylethers of formula CF₂═CFOCF₂OR_{f2} wherein R_{f2} is a C₁-C₆ fluoro- or perfluoroalkyl group, e.g. CF₃, C₂F₅, C₃F₇ or a C₁-C₆ (per)fluorooxyalkyl group comprising one or more ether groups, such as —C₂F₅—O—CF₃;
functional (per)fluoro-oxyalkylvinylethers of formula CF₂═CFOY₀, wherein Y₀ is a C₁-C₁₂ alkyl or (per)fluoroalkyl group, a C₁-C₁₂ oxyalkyl group or a C₁-C₁₂ (per)fluorooxyalkyl group comprising one or more ether groups and Y₀ comprising a carboxylic or sulfonic acid group, in its acid, acid halide or salt form;
fluorodioxoles, preferably perfluorodioxoles; and
cyclopolymerizable monomers of formula CR₇R₈═CR₉OCR₁₀R₁₁(CR₁₂R₁₃)ₐ(O)_{b}CR₁₄═CR₁₅R₁₆, wherein each R₇ to R₁₆, independently of one another, is selected from —F and a C₁-C₃ fluoroalkyl group, a is 0 or 1, b is 0 or 1 with the proviso that b is 0 when a is 1.

The polymer (F) may further comprise at least one hydrogenated monomer.

By the term “hydrogenated monomer”, it is hereby intended to denote an ethylenically unsaturated monomer comprising at least one hydrogen atom and free from fluorine atoms.

The term “at least one hydrogenated monomer” is understood to mean that the polymer (F) may comprise recurring units derived from one or more than one hydrogenated monomers. In the rest of the text, the expression “hydrogenated monomers” is understood, for the purposes of the present invention, both in the plural and the singular, that is to say that they denote both one or more than one hydrogenated monomers as defined above.

Non limitative examples of suitable hydrogenated monomers include, notably, non-fluorinated monomers such as ethylene, propylene, vinyl monomers such as vinyl acetate, acrylic monomers, like methyl methacrylate, butyl acrylate, as well as styrene monomers, like styrene and p-methylstyrene.

The polymer (F) may be semi-crystalline or amorphous.

The term “semi-crystalline” is hereby intended to denote a polymer (F) having a heat of fusion of from 10 to 90 J/g, preferably of from 30 to 60 J/g, more preferably of from 35 to 55 J/g, as measured according to ASTM D3418-08.

The term “amorphous” is hereby intended to denote a polymer (F) having a heat of fusion of less than 5 J/g, preferably of less than 3 J/g, more preferably of less than 2 J/g as measured according to ASTM D-3418-08.

The polymer (F) is typically selected from the group consisting of:

(1) polymers (F-1) comprising recurring units derived from at least one fluorinated monomer selected from tetrafluoroethylene (TFE) and chlorotrifluoroethylene (CTFE), and from at least one hydrogenated monomer selected from ethylene, propylene and isobutylene, optionally containing one or more additional comonomers, typically in amounts of from 0.01% to 30% by moles, based on the total amount of TFE and/or CTFE and said hydrogenated monomer(s);

(2) polymers (F-2) comprising recurring units derived from vinylidene fluoride (VDF), and, optionally, from one or more fluorinated monomers different from VDF;

(3) polymers (F-3) comprising recurring units derived from tetrafluoroethylene (TFE) and at least one fluorinated monomer different from TFE selected from the group consisting of:
perfluoroalkylvinylethers of formula CF₂═CFOR_{f1′} wherein R_{f1′} is a C₁-C₆ perfluoroalkyl group;
perfluoro-oxyalkylvinylethers of formula CF₂═CFOX₀ wherein X₀ is a C₁
C₁₂ perfluorooxyalkyl group comprising one or more ether groups, such as perfluoro-2-propoxy-propyl group;
C₃-C₈ perfluoroolefins, such as hexafluoropropene (HFP); and
perfluorodioxoles of formula (I):

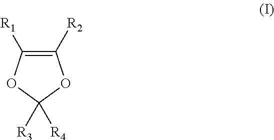

wherein R₁, R₂, R₃ and R₄, equal to or different from each other, are independently selected from the group consisting of —F, a C₁-C₆ fluoroalkyl group, optionally comprising one or more oxygen atoms, and a C₁-C₆ fluoroalkoxy group, optionally comprising one or more oxygen atoms; and (4) polymers (F-4) comprising recurring units derived from at least one cyclopolymerizable monomer of formula CR₇R₈═CR₉OCR₁₀R₁₁(CR₁₂R₁₃)ₐ(O)_{b}CR₁₄═CR₁₅R₁₆, wherein each R₇ to R₁₆, independently of one another, is selected from —F and a C₁-C₃ fluoroalkyl group, a is 0 or 1, b is 0 or 1 with the proviso that b is 0 when a is 1.

The polymer (F-1) preferably comprises recurring units derived from ethylene (E) and at least one of chlorotrifluoroethylene (CTFE) and tetrafluoroethylene (TFE).

The polymer (F-1) more preferably comprises:

(a) from 30% to 48%, preferably from 35% to 45% by moles of ethylene (E);

(b) from 52% to 70%, preferably from 55% to 65% by moles of chlorotrifluoroethylene (CTFE), tetrafluoroethylene (TFE) or mixture thereof; and

(c) up to 5%, preferably up to 2.5% by moles, based on the total amount of monomers (a) and (b), of one or more fluorinated and/or hydrogenated comonomer(s).

The comonomer is preferably a hydrogenated comonomer selected from the group of the (meth)acrylic monomers. The hydrogenated comonomer is more preferably selected from the group of the hydroxyalkylacrylate comonomers, such as hydroxyethylacrylate, hydroxypropylacrylate and (hydroxy)ethylhexylacrylate, and alkyl acrylate comonomers, such as n-butyl acrylate.

Among polymers (F-1), ECTFE copolymers, i.e. copolymers of ethylene and CTFE and, optionally, a third comonomer are preferred.

ECTFE polymers suitable in the process of the invention typically possess a melting temperature not exceeding 210° C., preferably not exceeding 200° C., even not exceeding 198° C., preferably not exceeding 195° C., more preferably not exceeding 193° C., even more preferably not exceeding 190° C. The ECTFE polymer has a melting temperature of advantageously at least 120° C., preferably of at least 130° C., still preferably of at least 140° C., more preferably of at least 145° C., even more preferably of at least 150° C.

The melting temperature is determined by Differential Scanning Calorimetry (DSC) at a heating rate of 10° C./min, according to ASTM D 3418.

ECTFE polymers which have been found to give particularly good results are those consisting essentially of recurring units derived from:

(a) from 35% to 47% by moles of ethylene (E);

(b) from 53% to 65% by moles of chlorotrifluoroethylene (CTFE).

End chains, defects or minor amounts of monomer impurities leading to recurring units different from those above mentioned can be still comprised in the preferred ECTFE, without this affecting properties of the material.

The melt flow rate of the ECTFE polymer, measured following the procedure of ASTM 3275-81 at 230° C. and 2.16 Kg, ranges generally from 0.01 to 75 g/10 min, preferably from 0.1 to 50 g/10 min, more preferably from 0.5 to 30 g/10 min.

The heat of fusion of polymer (F-1) is determined by Differential Scanning Calorimetry (DSC) at a heating rate of 10° C./min, according to ASTM D 3418.

The polymer (F-1) typically has a heat of fusion of at most 35 J/g, preferably of at most 30 J/g, more preferably of at most 25 J/g.

The polymer (F-1) typically has a heat of fusion of at least 1 J/g, preferably of at least 2 J/g, more preferably of at least 5 J/g.

The polymer (F-1) is advantageously a semi-crystalline polymer.

The polymer (F-2) preferably comprises:

(a′) at least 60% by moles, preferably at least 75% by moles, more preferably at least 85% by moles of vinylidene fluoride (VDF); and

(b′) optionally, from 0.1% to 15% by moles, preferably from 0.1% to 12% by moles, more preferably from 0.1% to 10% by moles of one or more fluorinated monomers selected from vinylfluoride (VF₁), chlorotrifluoroethylene (CTFE), hexafluoropropene (HFP), tetrafluoroethylene (TFE), trifluoroethylene (TrFE) and perfluoromethylvinylether (PMVE).

The polymer (F-2) may further comprise from 0.01% to 20% by moles, preferably from 0.05% to 18% by moles, more preferably from 0.1% to 10% by moles of at least one (meth)acrylic monomer as defined above.

The polymer (F-3) preferably comprises recurring units derived from tetrafluoroethylene (TFE) and at least 1.5% by weight, preferably at least 5% by weight, more preferably at least 7% by weight of recurring units derived from at least one fluorinated monomer different from TFE.

The polymer (F-3) preferably comprises recurring units derived from tetrafluoroethylene (TFE) and at most 30% by weight, preferably at most 25% by weight, more preferably at most 20% by weight of recurring units derived from at least one fluorinated monomer different from TFE.

The polymer (F-3) is more preferably selected from the group consisting of:
polymers (F-3A) comprising recurring units derived from tetrafluoroethylene (TFE) and at least one perfluoroalkylvinylether selected from the group consisting of perfluoromethylvinylether of formula CF₂═CFOCF₃, perfluoroethylvinylether of formula CF₂═CFOC₂F₅ and perfluoropropylvinylether of formula CF₂═CFOC₃F₇; and
polymers (F-3B) comprising recurring units derived from tetrafluoroethylene (TFE) and at least one perfluorodioxole of formula (I):

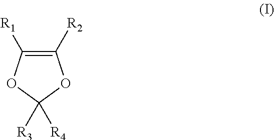

wherein R_{1,} R₂, R₃ and R₄, equal to or different from each other, are independently selected from the group consisting of —F, a C₁-C₃ perfluoroalkyl group, e.g. —CF₃, —C₂F₅, —C₃F₇, and a C₁-C₃ perfluoroalkoxy group optionally comprising one oxygen atom, e.g. —OCF₃, —OC₂F₅, —OC₃F₇, —OCF₂CF₂OCF₃; preferably, wherein R₁═R₂═—F and R₃═R₄ is a C₁-C₃ perfluoroalkyl group, preferably R₃═R₄═—CF₃ or wherein R₁═R₃═R₄═—F and R₂ is a C₁-C₃ perfluoroalkoxy, e.g. —OCF₃, —OC₂F₅, —OC₃F₇.

Non-limitative examples of suitable polymers (F-3A) include, notably, those commercially available under the trademark name HYFLON® PFA P and M series and HYFLON® MFA from Solvay Specialty Polymers Italy S.p.A.

The polymer (F-3B) more preferably comprises recurring units derived from tetrafluoroethylene (TFE) and at least one perfluorodioxole of formula (I) as defined above wherein R₁═R₃═R₄ ═—F and R₂═—OCF₃ or wherein R₁═R₂═—F and R₃═R₄═—CF₃.

Non-limitative examples of suitable polymers (F-3B) include, notably, those commercially available under the trademark name HYFLON® AD from Solvay Specialty Polymers Italy S.p.A. and TEFLON® AF from E. I. Du Pont de Nemours and Co.

The polymer (F-4) preferably comprises recurring units derived from at least one cyclopolymerizable monomer of formula CR₇R₈═CR₉OCR₁₀R₁₁ (CR₁₂R₁₃)ₐ(O)_{b}CR₁₄═CR₁₅R₁₆, wherein each R₇ to R₁₆, independently of one another, is —F, a=1 and b=0.

The polymer (F-4) is typically amorphous.

Non-limitative examples of suitable polymers (F-4) include, notably, those commercially available under the trademark name CYTOP® from Asahi Glass Company.

The polymer (F) is typically manufactured by suspension or emulsion polymerization processes.

The composition (C1) may further comprise one or more additives, such as, but not limited to, impact modifiers, UV stabilizers, UV blockers, plasticizers, processing aids, fillers, pigments, antioxidants, antistatic agents, surfactants, dispersing aids and fire retardants.

The skilled in the art, depending on the thickness of the layer (L1), will select the proper amount of one or more additives in the composition (C1).

For the purpose of the present invention, by the term “UV stabilizer” is understood to mean a chemical compound that can inhibit the physical and chemical processes of photo-induced degradation at wavelengths comprised between 300 nm and 400 nm.

Among preferred UV stabilizers, mention can be notably made of hindered amine light stabilizers (HALS).

For the purpose of the present invention, by the term “UV blocker” is understood to mean a chemical compound that can absorb electromagnetic radiation at wavelengths comprised between 300 nm and 400 nm.

Under step (i) of the process of the invention, the composition (C1) is typically manufactured using standard methods.

Usual mixing devices such as static mixers and high intensity mixers can be used. High intensity mixers are preferred for obtaining better mixing efficiency.

Under step (i) of the process of the invention, the composition (C1) is typically processed in molten phase using melt-processing techniques. The composition (C1) is usually processed by extrusion through a die at temperatures generally comprised between 100° C. and 300° C. to yield strands which are usually cut for providing pellets. Twin screw extruders are preferred devices for accomplishing melt compounding of the composition (C1).

The layer (L1) is typically manufactured by processing the pellets so obtained through traditional film extrusion techniques. Film extrusion is preferably accomplished using a flat cast film extrusion process or a hot blown film extrusion process.

The layer (L1) is preferably further processed by one or more planarization techniques.

Non-limitative examples of suitable planarization techniques include, notably, bistretching, polishing and planarization coating treatments.

It has been found that by further processing the layer (L1) by one or more planarization techniques its surface is rendered smooth so as to ensure higher interlayer adhesion and higher reflectivity of the multilayer mirror assembly so obtained.

Under step (ii) of the process of the invention, one surface of a fluoropolymer [polymer (F)] layer is treated by a radio-frequency glow discharge process in the presence of an etching gas.

By “radio-frequency glow discharge process”, it is hereby intended to denote a process powered by a radio-frequency amplifier wherein a glow discharge is formed by applying a voltage between two electrodes in a cell containing an etching gas. This glow discharge then passes through a jet head to arrive on the surface of the material to be treated.

By “etching gas”, it is hereby intended to denote either a gas or a mixture of gases suitable for use in a radio-frequency glow discharge process.

According to a first embodiment of the process of the invention, under step (ii) the etching gas is atmospheric air and the glow discharge thereby provided is a corona discharge.

According to a second embodiment of the process of the invention, under step (ii) the etching gas is free from oxygen and the glow discharge is a plasma discharge.

The radio-frequency glow discharge process is typically carried out at a radio-frequency comprised between 10 kHz and 100 kHz.

The radio-frequency glow discharge process is typically carried out at a voltage comprised between 5 kV and 20 kV.

The etching gas is typically selected from N₂, NH₃, CO₂, H₂ and mixtures thereof.

Under step (ii) of the process of the invention, one surface of a fluoropolymer [polymer (F)] layer is preferably treated by a radio-frequency plasma discharge process.

Very good results have been obtained by treating, under step (ii) of the process of the invention, one surface of the polymer (F) layer by radio-frequency plasma discharge under atmospheric pressure at a radio-frequency of 40 kHz and a voltage of 20 kV.

Atmospheric-pressure plasmas have prominent technical significance because, in contrast with low-pressure plasma or high-pressure plasma, no reaction vessel is needed to ensure the maintenance of a pressure level differing from atmospheric pressure.

Under step (ii) of the process of the invention, the inner surface of the first layer [layer (L1)] is advantageously continuously treated by a radio-frequency glow discharge process in the presence of an etching gas.

The Applicant has found that, after treatment of the layer (L1) by a radio-frequency glow discharge process in the presence of an etching gas, the layer (L1) remains successfully optically transparent.

The Applicant thinks, without this limiting the scope of the invention, that by a radio-frequency glow discharge process in the presence of NH₃ and/or N₂ atmosphere nitrogen-based functionalities such as amine (—NH₂) , imine (—CH═NH) and nitrile (—CN) functionalities are grafted on the treated inner surface of the layer (L1).

In particular, the Applicant thinks, without this limiting the scope of the invention, that by a radio-frequency glow discharge process in the presence of NH₃ atmosphere amine (—NH₂) functionalities are grafted on the treated inner surface of the layer (L1).

Also, the Applicant has found that the so treated layer (L1) provides outstanding interlayer adhesion with a layer (L2) applied thereto by electroless deposition.

For the purpose of the present invention, by “electroless deposition” it is meant a redox process typically carried out in a plating bath between a metal cation and a proper chemical reducing agent suitable for reducing said metal cation in its elemental state.

Under step (iii) of the process of the invention, the treated inner surface of the layer (L1) is typically contacted with an electroless metallization catalyst thereby providing a catalytic surface and said catalytic surface is then typically contacted with an electroless metallization plating bath comprising at least one metal compound [compound (M)] thereby providing a layer (L1) having the inner surface coated with a layer (L2).

Under step (iii) of the process of the invention, the treated inner surface of the layer (L1) is advantageously continuously adhered to a layer (L2).

The layer (L2) has typically a thickness comprised between 0.05 μm and 5 μm, preferably between 0.8 μm and 1.5 μm.

A variety of compounds may be employed as electroless metallization catalysts according to the process of the invention such as palladium, platinum, rhodium, iridium, nickel, copper, silver and gold catalysts.

The electroless metallization catalyst is preferably selected from palladium catalysts such as PdCl₂.

The treated inner surface of the layer (L1) is typically contacted with the electroless metallization catalyst in liquid phase in the presence of at least one liquid medium.

The electroless metallization plating bath typically comprises at least one compound (M), at least one reducing agent, at least one liquid medium and, optionally, one or more additives.

Non-limitative examples of suitable liquid media include, notably, water, organic solvents and ionic liquids.

Among organic solvents, alcohols are preferred such as ethanol.

Non-limitative examples of suitable ionic liquids include, notably, those comprising as cation a sulfonium ion or an imidazolium, pyridinium, pyrrolidinium or piperidinium ring, said ring being optionally substituted on the nitrogen atom, in particular by one or more alkyl groups with 1 to 8 carbon atoms, and on the carbon atoms, in particular by one or more alkyl groups with 1 to 30 carbon atoms.

The ionic liquid is advantageously selected from those comprising as anion those chosen from halides anions, perfluorinated anions and borates.

Non-limitative examples of suitable additives include, notably, salts, buffers and other materials suitable for enhancing stability of the catalyst in the liquid composition.

The compound (M) typically comprises one or more metal salts.

The compound (M) preferably comprises one or more metal salts deriving from Rh, Ir, Ru, Ti, Re, Os, Cd, TI, Pb, Bi, In, Sb, Al, Ti, Cu, Ni, Pd, V, Fe, Cr, Mn, Co, Zn, Mo, W, Ag, Au, Pt, Ir, Ru, Pd, Sn, Ge, Ga and alloys thereof.

Preferably, the compound (M) comprises one or more metal salts deriving from at least one of Al, Ni, Cu, Ag and alloys thereof.

The electroless metallization plating bath preferably comprises at least one compound (M) comprising one or more metal salts, at least one reducing agent, at least one liquid medium and, optionally, one or more additives.

The electroless metallization bath typically further comprises one or more reducing agents.

Non-limitative examples of suitable reducing agents include, notably, formaldehyde, sodium hypophosphite and hydrazine.

The process of the invention may further comprise a step (iv) wherein the opposite side of the layer (L2) is applied by electro-deposition onto a layer ( L3).

For the purpose of the present invention, by “electro-deposition” it is meant a process using electrical current to reduce metal cations from an electrolytic solution so that a layer (L3) of said metal in its elemental state is adhered onto a layer (L2).

The electrolytic solution preferably comprises at least one metal salt deriving from Al, Ni, Cu, Ag, Au and alloys thereof, at least one metal halide and, optionally, at least one ionic liquid as defined above.

Under step (iv) of the process of the invention, if any, the opposite surface of the layer (L2) is advantageously continuously adhered to a layer (L3).

According to a preferred embodiment of the invention, the multilayer mirror assembly of the invention comprises a layer (L1) having a treated inner surface, directly adhered to said treated inner surface of the layer (L1), a layer (L2) made of Ag in its elemental state and, directly adhered to the opposite side of said layer (L2), a layer (L3) made of at least one metal selected from Al, Ni, Cu, Ag, Au and alloys thereof in its elemental state.

The layer (L3) has typically a thickness comprised between 0.1 μm and 30 μm, preferably between 1 μm and 15 μm.

The process of the invention may also further comprises a step (v) wherein one or more layers are applied onto the opposite side of a layer (L2) or a layer (L3), if any.

Under step (v) of the process of the invention, if any, one or more layers are applied onto the opposite side of a layer (L2) of a layer (L3), if any, by techniques commonly known in the art.

Among conventional techniques, mention can be notably made of melt-processing techniques such as colaminating, coextrusion, for example coextrusion-laminating, coextrusion-blow moulding and coextrusion-moulding, extrusion-coating, coating, overinjection-moulding or coinjection-moulding techniques.

The choice of one or other of these techniques is typically made on the basis of the material and of the thickness of each of said layers.

Non-limitative examples of layers suitable for use in step (v) of the process of the invention include, notably, layers made of polymers selected from the group consisting of polyethylene terephthalate, polyethylene naphthalate, polyamides and ethylene vinyl acetate.

The solar concentrator of the invention is preferably a parabolic mirror.

The parabolic mirror is typically manufactured by a cold curving process.

Should the disclosure of any patents, patent applications, and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

Raw materials

ECTFE (50:50 molar ratio)

Manufacture of a Fluoropolymer Layer

For manufacturing thin films, pellets of ECTFE were processed in a cast extrusion film line equipped with a 2.5″ single stage extruder. Extruder is connected to the die via an adapter equipped with breaker plate. The die was a 1370 mm wide auto-gauge die. Upon exit from the die, molten tape was casted on three subsequent chill rolls, whose speed was adapted so as to obtain a film. Total thickness and thickness variation along the width are controlled by a Beta-ray gauge control system with retrofit to the die.

The following processing conditions were used for a 100 μm thick film (see Tables 1 and 2 here below).

TABLE 1

| Zone | Temperature [° C.] |
|---|---|
| Main Barrel Zone 1 | 275 |
| Main Barrel Zone 2 | 280 |
| Main Barrel Zone 3 | 280 |
| Main Barrel Zone 4 | 280 |
| Clamp | 280 |
| Adapter 1 | 280 |
| Adapter 2 | 280 |

TABLE 2

| Zone | Temperature [° C.] |
|---|---|
| Adapter | 280 |
| Die Zone 1 | 285 |
| Die Zone 2 | 285 |
| Die Zone 3 | 285 |
| Die Zone 4 | 285 |
| Die Zone 5 | 285 |
| Top Roll | 90 |
| Center Roll | 170 |
| Bottom Roll | 170 |

The final width of the film, after edge cutting, was about 1050 mm.

Surface Modification of a Fluoropolymer Layer

The fluoropolymer film so obtained was treated by a radio-frequency plasma discharge process. The etching gas used was N₂. Working radio-frequency and voltage had values of 40 kHz and 20 kV, respectively. As evidenced by FT-IR Attenuated Total Reflectance (ATR) spectra of the plasma-treated fluoropolymer film so obtained, N-containing functionalities were grafted onto the plasma-treated surface of said fluoropolymer film such as amine (—NH₂), imine (—CH═NH) and nitrile (—CN) functionalities.

### EXAMPLE 1

### Metallization Process of a Fluoropolymer Layer

The fluoropolymer film treated by plasma as detailed hereinabove was coated with metallic nickel by electroless plating. Prior to the nickel deposition, the fluoropolymer layer was catalyzed by the wet process of Pd activation. This activation process was carried out by the immersion of the fluoropolymer layer in an aqueous solution containing 0.03 g/L of PdCl₂ for 1 min, resulting in the substrate being entirely covered with Pd particles at a high density.

The fluoropolymer layer was immersed in the aqueous plating bath which contained 29.86 g/L nickel acetate tetrahydrate, 28.15 g/L sodium hypophosphite and 45.04 g/L lactic acid. The plating temperature was 85° C. and its pH value was 9.

### COMPARATIVE EXAMPLE 1

### Metallization Process of a Fluoropolymer Layer

A fluoropolymer film was prepared following the same procedure as detailed above under Example 1, but without surface modification by plasma of the fluoropolymer film.

### COMPARATIVE EXAMPLE 2

### Metallization Process of a Fluoropolymer Layer

The fluoropolymer film treated by plasma as detailed hereinabove was coated with metallic nickel by sputtering according to usual techniques.

Evaluation of Adhesion of the Metallized Fluoropolymer Assembly

Adhesion of the metallic layer on the fluoropolymer substrates has been characterized by means of ASTM D3359 cross cut test standard procedure. Using a cutting tool, two series of perpendicular cuts were applied on the metallic layer in order to create a lattice pattern on it. A piece of tape was then applied and smoothened over the lattice and removed with an angle of 180° with respect to the metallic layer. The adhesion of metallic layer on the fluopolymer was then assessed by comparing the lattice of cuts with the ASTM D3359 standard procedure. The classification of test results ranged from 5B to 0B, whose descriptions are depicted in Table 3.

TABLE 3

| ASTM D3359 | |
|---|---|
| Classification | Description |
| 5B | The edges of the cuts are completely smooth; none |
| | of the squares of the lattice is detached. |
| 4B | Detachment of flakes of the coating at the |
| | intersections of the cuts. A cross cut area not |
| | significantly greater than 5% is affected. |
| 3B | The coating has flaked along the edges and/or at the |
| | intersection of the cuts. A cross cut area significantly |
| | greater than 5%, but not significantly greater than |
| | 15% is affected. |
| 2B | The coating has flaked along the edges of the cuts |
| | partly or wholly in large ribbons, and/or it has flaked |
| | partly of wholly on different parts of the squares. A |
| | cross cut area significantly greater than 15%, but not |
| | significantly greater than 65%, is affected. |
| 1B | The coating has flaked along the edges of the cuts in |
| | large ribbons and/or some squares have detached |
| | partly or wholly. A cross cut area significantly greater |
| | than 35%, but not significantly greater than 65%, is |
| | affected. |
| 0B | Any degree of flaking that cannot be classified even |
| | by classification 1B. |

The adhesion values for metallized fluoropolymer assemblies obtained according to Example 1 and comparative Examples 1 and 2 are set forth in Table 4 here below.

TABLE 4

| | Adhesion |
|---|---|
| Run | ASTM D3359 |
| Example 1 | 5B |
| C. Example 1 | 0B |
| C. Example 2 | 1B |

It has been thus found that the multilayer mirror assembly according to the present invention advantageously provides for outstanding interlayer adhesion properties as compared with multilayer assemblies according to comparative Examples 1 and 2.

No interlayer adhesion was observed for the multilayer assembly obtained according to comparative Example 1, wherein the surface of the fluoropolymer film was not modified by plasma treatment.

Evaluation of adhesion and flexibility properties of the metallized fluoropolymer assembly

Indication on adhesion of metallic film on the fluoropolymer layer and assessment of flexibility of the metallized fluoropolymer assembly was carried out by means of a bending test.

Ten cylindrical tools with different radius of curvature ranging from 1 to 10 mm served as profile where the multilayer assembly was positioned and bended in order to match the profiles of the cylinders.

The results of the bending test are set forth in Table 5 here below.

TABLE 5

| | Lower radius |
|---|---|
| | of curvature |
| | tested before |
| Run | failure |
| Example 1 | 1 mm |
| C. Example 2 | 2 mm |

It has been thus found that the multilayer mirror assembly according to the present invention advantageously provides for higher flexibility properties while providing for outstanding interlayer adhesion properties as compared with the multilayer assembly according to comparative Example 2.

Evaluation of Transmittance of the Metallized Fluoropolymer Assembly

Transmittance evaluation of the metallized fluoropolymer assemblies was carried out using double beam spectrophotometer Perkin Elmer Lambda 2. Wavelength measurement range was 200-1000 nm and data point spacing was 1 nm. The results of the transmittance measurements are set forth in Table 6 here below.

TABLE 6

| | | Percentage of |
|---|---|---|
| Run | Wavelength | transmitted light |
| Fluoropolymer film | 500 nm | 80% |
| Plasma-treated fluoropolymer film | 500 nm | 80% |
| C. Example 1 | 500 nm | 80% |
| Example 1 | 500 nm | 0.7% |
| C. Example 2 | 500 nm | 2.4% |

It has been thus shown that the multilayer mirror assembly according to the present invention, due to a metal layer substantially continuously adhered to the fluoropolymer layer, advantageously provides for very low transmittance properties as compared with non-metallized fluoropolymer layer and with the multilayer assembly according to comparative Example 1 showing no interlayer adhesion properties with the metal layer.

Also, the multilayer mirror assembly according to the present invention advantageously provides for transmittance properties lower than those provided by known multilayer assemblies according to comparative Example 2.

In view of the above, the multilayer mirror assembly of the present invention is particularly suitable for use in solar concentrators due to its enhanced interlayer adhesion properties combined with its outstanding reflection, flexibility and weatherability properties.

1. A process for the manufacture of a multilayer mirror assembly, said process comprising the following steps:
treating, by a radio-frequency glow discharge process in the presence of an etching gas, the inner surface of an optically transparent layer (L1) made of a composition (C1) comprising at least one fluoropolymer [polymer (F)], said layer (L1) having an inner surface and an outer surface;
, and
applying, by electroless deposition, a metal layer (L2) onto the treated inner surface of the layer (L1), said layer (L2) being made of a composition (C2) comprising at least one metal compound (M).

2. The process according to claim 1, wherein polymer (F) is selected from the group consisting of:
(1) polymers (F-1) comprising recurring units derived from at least one fluorinated monomer selected from tetrafluoroethylene (TFE) and chlorotrifluoroethylene (CTFE), and from at least one hydrogenated monomer selected from ethylene, propylene and isobutylene, optionally containing one or more additional comonomers;
(2) polymers (F-2) comprising recurring units derived from vinylidene fluoride (VDF), and, optionally, from one or more fluorinated monomers different from VDF;
(3) polymers (F-3) comprising recurring units derived from tetrafluoroethylene (TFE) and at least one fluorinated monomer different from TFE selected from the group consisting of:
perfluoroalkylvinylethers of formula CF₂═CFOR_{f1′} wherein R_{f1′} is a C₁-C₆ perfluoroalkyl group;
perfluoro-oxyalkylvinylethers of formula CF₂═CFOX₀ wherein X₀ is a C₁-C₁₂ perfluorooxyalkyl group comprising one or more ether groups;
C₃-C₈ perfluoroolefins, such as hexafluoropropene (HFP); and
perfluorodioxoles of formula (I): 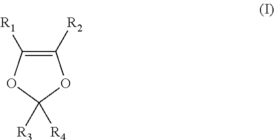
wherein R₁, R₂, R₃ and R₄, equal to or different from each other, are independently selected from the group consisting of —F, a C₁-C₆ fluoroalkyl group, optionally comprising one or more oxygen atoms, and a C₁-C₆ fluoroalkoxy group, optionally comprising one or more oxygen atoms; and
(4) polymers (F-4) comprising recurring units derived from at least one cyclopolymerizable monomer of formula CR₇R₈═CR₉OCR₁₀R₁₁(CR₁₂R₁₃)ₐ(O)_{b}CR₁₄═CR₁₅R₁₆, wherein each R₇ to R₁₆, independently of one another, is selected from —F and a C₁-C₃ fluoroalkyl group, a is 0 or 1, b is 0 or 1 with the proviso that b is 0 when a is 1.

3. The process according to claim 2, wherein polymer (F) is a polymer (F-1) comprising:
(a) from 30% to 48% by moles of ethylene (E);
(b) from 52% to 70% by moles of chlorotrifluoroethylene (CTFE), tetrafluoroethylene (TFE) or mixture thereof; and
(c) up to 5% by moles, based on the total amount of monomers (a) and (b), of one or more fluorinated and/or hydrogenated comonomer(s).

4. The process according to claim 1, wherein the etching gas is free from oxygen and the glow discharge is a plasma discharge.

5. The process according to claim 1, wherein the etching gas is selected from N₂, NH₃, CO₂, H₂ and mixtures thereof.

6. The process according to claim 1, wherein layer (L1) has a transmittance of at least 70% of the incident electromagnetic radiation.

7. The process according to claim 1, wherein the electroless deposition comprises contacting the treated inner surface of layer (L1) with an electroless metallization catalyst thereby providing a catalytic surface and contacting said catalytic surface with an electroless metallization plating bath comprising at least one metal compound (M) thereby providing a layer (L1) having the inner surface coated with a layer (L2).

8. The process according to claim 7, wherein the electroless metallization plating bath comprises at least one metal compound (M) comprising one or more metal salts, at least one reducing agent, at least one liquid medium and, optionally, one or more additives.

9. The process according to claim 1, said process further comprising:
applying, by electro-deposition, a metal layer (L3) onto the side of layer (L2) that is opposite to layer (L1), said layer (L3) being made of a composition (C3) comprising at least one metal compound (M), said composition (C3) being equal to or different from composition, and
optionally, applying one or more further layers onto the side of layer (L3) that is opposite to layer (L1).

10. A multilayer mirror assembly obtainable by the process according to claim 1.

11. The multilayer mirror assembly according to claim 10, wherein nitrogen-based functionalities are grafted on the treated inner surface of layer (L1).

12. The multilayer mirror assembly according to claim 10, wherein layer (L2) has a thickness comprised between 0.05 μm and 5 μm.

13. The multilayer mirror assembly according to claim 10, comprising a layer (L3) wherein layer (L3), has a thickness comprised between 0.1 μm and 30 μm.

14. A solar concentrator comprising at least one multilayer mirror assembly according to claim 10.

15. The solar concentrator according to claim 14, further comprising:
a heat transfer fluid.

16. The solar concentrator according to claim 14, further comprising:
a photovoltaic cell.

17. The process according to claim 3, wherein polymer (F) is a polymer (F-1) comprising:
(a) from 35% to 45% by moles of ethylene (E);
(b) from 55% to 65% by moles of chlorotrifluoroethylene (CTFE), tetrafluoroethylene (TFE) or mixture thereof; and
(c) up to 2.5% by moles, based on the total amount of monomers (a) and (b), of one or more fluorinated and/or hydrogenated comonomer(s).

18. The process according to claim 6, wherein layer (L1) has a transmittance of at least 85% of the incident electromagnetic radiation.

19. The multilayer mirror assembly according to claim 12, wherein layer (L2) has a thickness comprised between 0.8 μm and 1.5 μm.

20. The multilayer mirror assembly according to claim 13, wherein layer (L3) has a thickness comprised between 1 μm and 15 μm.
